(19) United States
(12) Patent Application Publication
(10) Pub. No.: US 2026/0274205 A1
(43) Pub. Date: Sep. 17, 2026

(54) METHOD FOR ESTABLISHING A COMMUNICATION CONNECTION BETWEEN A NEW VEHICLE KEY AND A VEHICLE AND SYSTEM FOR CARRYING OUT THE METHOD

(71) Applicant: MERCEDES-BENZ GROUP AG, Stuttgart (DE)

(72) Inventors: Stefan BOHM, Aichtal (DE); Christian RUPERT, Herrenberg (DE); Dirk HASSERT, Wangen (DE); Thomas FISCHER, Lichtenwald (DE); Sepideh SÄNGER, Leonberg (DE)

(21) Appl. No.: 19/471,885

(22) PCT Filed: Feb. 15, 2024
(86) PCT No.: PCT/EP2024/053868

§ 371 Date: Oct. 2, 2025

(30) Foreign Application Priority Data
Apr. 3, 2023 (DE) 10 2023 001 311.0

(51) Int. Cl. B60R 25/24; G07C 9/00; H04W 76/11; H04W 76/14

(52) U.S. Cl. CPC B60R 25/24; G07C 9/00817; H04W 76/11; H04W 76/14

(57) ABSTRACT

A communication connection between a new vehicle key and a vehicle is established using a key connection process. A training application checks whether 1) a user is in the vehicle and a digital permission to connect the new vehicle key to the vehicle has been provided to the user in a backend application of the learning application, 2) the new vehicle key is in the vehicle, and 3) a vehicle key is in the vehicle. After successful verification of the criteria 1) to 3), the new vehicle key is communicatively connected to the vehicle in a coupling step.

### BACKGROUND AND SUMMARY OF THE INVENTION

Exemplary embodiments of the present invention relate to a method for establishing a communication connection between a new vehicle key and a vehicle. In particular, the invention relates to a system for carrying out the proposed method.

A device for controlling an access authorization and/or driving authorization for a vehicle or a method for training a vehicle key to a vehicle are known from DE 10 2012 012 389 A1 and DE 10 2016 201 601 A1 .

By introducing the digital vehicle key, the requirements for the conventional physical vehicle key and its role as a necessary component of user/vehicle interaction have fundamentally changed. Previously, it was common practice to equip vehicles with a single key pair, wherein the user of the vehicle received this key pair upon delivery of the vehicle. If a key was lost or damaged, a replacement key was ordered, which was then “trained” to the vehicle, i.e., communicatively connected, by an authorized workshop by means of a diagnostic tester or key programming device. However, a workshop visit means additional time and financial expenditure for the user of the vehicle, which is undesirable in terms of customer convenience.

Exemplary embodiments of the invention are thus directed to an improved or at least a different embodiment for a method for establishing a communication connection between a new vehicle key and a vehicle. In particular, a system is to be provided that can carry out the proposed method.

To do so, a method for establishing a communication connection between a new vehicle key and a vehicle, which could also be referred to as a pairing method, is proposed. In the method, a mobile communication device, for example a mobile phone (smartphone) or a different mobile device, e.g., an iPad, with a storage medium, a programmable vehicle key that is communicatively connected to the vehicle, and a programmable new vehicle key that can be communicatively connected to the vehicle are first provided. Here, it is clear to a person skilled in the art that the new vehicle key is not yet connected to the vehicle at this moment, but is merely set up for such a connection. The vehicle key and the new vehicle key can be designed to be programmable, e.g., via a wireless key communication interface of an electronic ignition switch of the vehicle. The new vehicle key can be simple in terms of technology and design and can be implemented e.g., as an NFC card. Furthermore, a training application, i.e., a training program, is provided, which has a user application provided in the storage medium of the mobile communication device and able to be implemented by the user, and a backend application provided in a vehicle backend, able to be implemented, and wirelessly connected to the mobile communication device and/or the vehicle. Presently, the vehicle backend can be understood in the sense of a server landscape of the vehicle manufacturer of the vehicle, which is expediently set up to provide the training application and, if applicable, further services and functions for the vehicle. Furthermore, it is provided that a digital permission for connecting the new vehicle key to the vehicle is provided or can be provided in the backend application for the user. In the scope of the proposed method, it is then provided that a user of the communication device, in particular an authorized seller of the new vehicle key, registers, i.e., logs in, to the training application by means of the user application, for example by entering personal data, in particular a user name and password. A key connecting process is then initiated by the user. The key connecting process is expediently provided by a vehicle infotainment device of the vehicle and/or initiated by the user by means of a user communication interface of the vehicle infotainment device. It is substantial that, in the scope of the key connecting process, it is checked, for example by means of the training application, as to whether
1) the user is in the vehicle and a digital permission to connect the new vehicle key to the vehicle has been provided for the user in the backend application. Furthermore, it is checked in this step as to whether the user is registered (logged in) to the training application. The identity of the user can be confirmed by successfully logging in.
2) the new vehicle key is in the vehicle, which may be possible via a transponder interface of the vehicle that communicates wirelessly, e.g., inductively, with the mobile communication device,
3) the vehicle key is in the vehicle, which may be possible via radio tracking.

After successful verification of criteria 1) to 3), it is provided in the scope of the method that the new vehicle key is communicatively connected to the vehicle in a coupling step.

The method presented here can, for example, be carried out directly upon purchase of the new vehicle key by an authorized user (e.g., a seller). Here, advantageously, no additional technical equipment such as a diagnostic tester or key programming device or similar is required, such that a visit to a workshop, which has been required up until now, is no longer necessary, whereby customer convenience is improved. Thus, overall a simple and seamless connection of the new vehicle key to the vehicle is possible.

It is expedient when, in the scope of the proposed method, key programming data for connecting the new vehicle key to the vehicle is generated by the vehicle backend during the coupling step and provided to the vehicle. The vehicle then, in turn, makes the received key programming data available to the new vehicle key, such that, based on the key programming data, a communication connection can be established between the new vehicle key and the vehicle, in such a way that the vehicle can be used by means of the new vehicle key. The communication connection can be implemented, for example, through transponder communication. Thus, the new vehicle key can be easily and securely communicatively connected to the vehicle.

Furthermore, it is expedient when the key connection process is initialized by the user by means of a user communication interface of a vehicle infotainment device. It is expedient when the proposed method or key connection process is deactivated, i.e., not available, during normal operation of the vehicle. However, the user, for example an authorized seller of the new vehicle key or an authorized workshop, can activate the proposed method or key connection process before carrying out the proposed method, in particular via a telematics service that communicates with the vehicle. Once the new vehicle key has been successfully connected to the vehicle, the proposed method or the key connection process can be deactivated either manually or automatically.

The user communication interface of the vehicle infotainment device can preferably be implemented as a screen, e.g., a touchscreen. The user communication interface is arranged, for example, in the vehicle interior of the vehicle and can be easily accessed and viewed by the vehicle user. Here, it is expedient for the user communication interface to display an icon visible to the user for the proposed method or for the key connection process, which, when actuated, can initialize/start the proposed method or the key connection process. It is understood that the icon is not visible to the user when the execution of the proposed method or the key connection process is deactivated.

It is expedient, in the scope of the proposed method, when testing the criterion 1) by means of a vehicle infotainment device of the vehicle, to provide an authentication request together with a vehicle identification number of the vehicle, the so-called VIN, to a telematics application provided in the vehicle backend. Then, it is provided that, upon receiving the authentication request, the telematics application generates a random-based authentication code, e.g., a QR code, that has a unique authentication identifier, e.g., a UUID (Universally Unique Identifier). The generated authentication code and the vehicle identification number of the vehicle are then allocated to each other by the telematics application and stored as an authentication data packet in a database of the vehicle backend or the telematics application. The telematics application then provides the authentication code to the vehicle infotainment system of the vehicle, wherein the vehicle infotainment system of the vehicle has a user communication interface for the user, and the authentication code is provided and displayed at the user communication interface. The displayed authentication code is then provided to the mobile communication device, for example by a scanning process to be performed by the user by means of the mobile communication device, the mobile communication device then providing the authentication code to the user application, wherein the user application provides the authentication code, together with an identifier of a user session, to the backend application. It is then provided that the backend application carries out an authentication in which the authentication identifier of the authentication code is provided to the telematics application, wherein the telematics application checks whether the provided authentication identifier of the authentication code is valid by searching for an authentication data packet in the database of the telematics application for the authentication identifier, provided by the backend application, of the authentication code, the authentication data packet having an authentication identifier matching the authentication identifier provided by the backend application. Here, the authentication identifier of the authentication code is valid when an authentication data packet with a matching authentication identifier is found. If authentication is successful, the telematics application provides the vehicle identification number of the vehicle to the backend application, thereby confirming that the user is in the vehicle and that a digital permission to connect the new vehicle key to the vehicle has been provided to the user in the backend application. This procedure ensures that a user authorized to establish a communication connection between the new vehicle key and the vehicle (e.g., the seller) is actually in the vehicle. Moreover, it is checked whether digital permission to connect the new vehicle key to the vehicle has been provided to the user in the backend application. Permission to connect the new vehicle key can be granted, for example, by the manufacturer of the vehicle.

When checking the criterion 2), it is furthermore expedient if a key identifier of the new vehicle key located in the vehicle is read from the new vehicle key by means of a key communication interface of an electronic ignition switch of the vehicle, wherein the key identifier of the new vehicle key and a vehicle identification number of the vehicle are provided to a telematics application provided in the vehicle backend, and wherein the telematics application provides the key identifier of the new vehicle key together with the vehicle identification number of the vehicle to the backend application. This ensures the presence of the new vehicle key in the vehicle, which is essential for establishing a communication connection between the new vehicle key and the vehicle.

It is expedient when, in the scope of the proposed method, when checking the criterion 3), a key presence query is transmitted to a telematics application provided in the vehicle backend by means of a key data management application provided in the vehicle backend, wherein the telematics application sends the key presence query to a key communication interface of an electronic ignition switch of the vehicle, wherein the ignition switch locates and identifies the vehicle key, for example via radio, and generates presence information, wherein the ignition switch provides the presence information with a vehicle identification number of the vehicle to the telematics application, wherein the telematics application provides the presence information with the vehicle identification number of the vehicle to the key data management application, which checks the presence information. This ensures the presence of the vehicle key in the vehicle, which is essential for establishing a communication connection between the new vehicle key and the vehicle.

In the scope of the proposed method, it can be provided, in particular, that during the key connection process, the mobile communication device communicates wirelessly with the vehicle via a communication interface of a vehicle infotainment device of the vehicle. Thus, communication between the mobile communication device and the vehicle can be implemented relatively easily.

It is expedient when the new vehicle key and/or the vehicle key communicate wirelessly with the vehicle during the key connection process via a key communication interface of an electronic ignition switch of the vehicle. Thus, communication between the new vehicle key and/or the vehicle key and the vehicle can be realized relatively easily.

Furthermore, it is expedient when the mobile communication device and/or a vehicle infotainment device of the vehicle communicate wirelessly with the vehicle backend via a mobile network. Thus, communication between the communication device and/or the vehicle infotainment device and the vehicle backend can be realized relatively easily.

According to a further basic idea of the invention, a system for carrying out the method according to the preceding description is provided. The system has a vehicle, a vehicle backend allocated to the vehicle, a mobile communications device, for example a mobile phone (smartphone) or a different mobile device, e.g., an iPad, with a storage medium, a programmable vehicle key communicatively connected to the vehicle, and a programmable new vehicle key that can be communicatively connected to the vehicle. It is clear to a person skilled in the art that the new vehicle key is not yet connected to the vehicle at this moment, but rather is merely set up for such a connection. Furthermore, it has a training application, i.e., a connection program, which has an executable user application provided in the storage medium of the mobile communications device, and an executable backend application provided in the vehicle backend and wirelessly communicatively connected to the mobile communications device. Furthermore, it is provided that the vehicle has an electronic ignition switch with a key communication interface for communicating with the vehicle key and the new vehicle key, and a vehicle infotainment device with a user communication interface for communicating with a user, and that, in addition to the backend application, the vehicle backend has a telematics application with a database and a key data management application. Thus, an advantageous system is specified by means of which the proposed method can be carried out.

In summary, it should be noted that: the present invention expediently relates to a method for establishing a communication connection between a new vehicle key and a vehicle, in which, as part of a key connection process, it is checked by means of a training application as to whether
1) a user is in the vehicle and a digital permission to connect the new vehicle key to the vehicle has been provided to the user in a backend application of the training application,
2) the new vehicle key is in the vehicle,
3) a vehicle key is in the vehicle, wherein, after successfully checking criteria 1) to 3), the new vehicle key is communicatively connected to the vehicle in a coupling step. In particular, the invention relates to a system that is set up to carry out the proposed method.

Further important features and advantages of the invention emerge from the sub-claims, from the drawings and from the corresponding description of the figures by means of the drawings.

It is understood that the previously mentioned features and those still to be explained below can be used not only in the respectively specified combination, but also in other combinations or on their own, without leaving the scope of the present invention.

Preferred exemplary embodiments of the invention are depicted in the drawings and are explained in more detail in the description below, wherein the same reference numerals relates to the same or similar or functionally identical components.

### BRIEF DESCRIPTION OF THE DRAWING FIGURES

Here are shown, schematically in each case:

FIG. 1 a schematic flowchart of the proposed method,

FIG. 2 a simplified schematic activity diagram of the proposed method and finally

FIG. 3 a further simplified schematic activity diagram of the proposed method.

### DETAILED DESCRIPTION

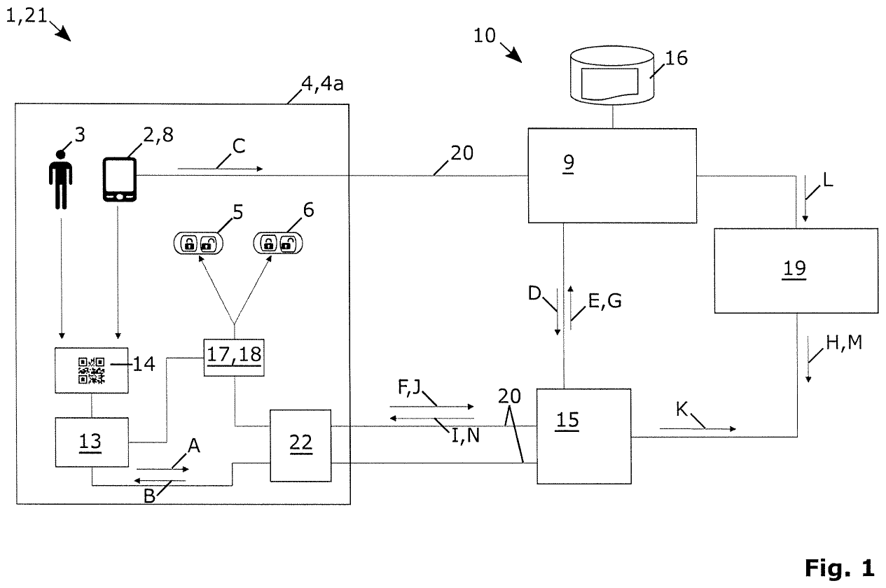

FIG. 1 shows a method, labelled overall with 1, to establish a communication connection between a new vehicle key 6 and a vehicle 4. It could also be referred to as a pairing method or method for training a new vehicle key 6 on a vehicle 4 without leaving the scope of the invention. It is proposed that, within the scope of method 1, a system 21 for executing method 1 with the following peripheral elements is first provided:
a mobile communication device 2, for example a mobile phone (smartphone) or a different mobile device, e.g., iPad, with a storage medium, a programmable vehicle key 5 communicatively connected to the vehicle 4, and a programmable new vehicle key 6, which is not communicatively connected to the vehicle 4 but can be communicatively connected to the vehicle 4,
a conventional vehicle 4 having a vehicle interior 4a for a user, an electronic ignition switch 17 with a key communication interface 18 for communicating with the vehicle key 5 and the new vehicle key 6, and a vehicle infotainment device 13 with a user communication interface 14, implemented, for example, by a screen or a touchscreen, visible and operable from the vehicle interior 4a, for communicating with the user 3 and/or the mobile communication device 2,
a training application, which could also be referred to as a connection program and which has an implementable user application 8 provided in the storage medium of the mobile communication device 2 and an implementable backend application 9 provided in a vehicle backend 10 and wirelessly communicatively connected to the mobile communication device 2, and
the vehicle backend 10 allocated to the vehicle 4, which presently is understood in the sense of a server landscape of the vehicle manufacturer of the vehicle 4, wherein, in addition to the backend application 9, it has a telematics application 15, a database 16 allocated to the backend application 9, and a key data management application 19. The mobile communication device 2 can communicate wirelessly with the backend application 9 via a mobile network 20. The vehicle infotainment device 13 and the ignition switch 17 can also communicate wirelessly with the telematics application 15 via the mobile network 20. To do so, the vehicle 4 exemplarily has a telematics control device 22, which can form a corresponding connection to the telematics application 15 via the mobile network 20 and which is communicatively connected to the vehicle infotainment device 13 and the ignition switch 17.

Within the scope of method 1, it is provided that a digital permission for connecting the new vehicle key 6 to the vehicle 4 is provided in the database 16 in the backend application 9 for the user 3. The database 16 stores the digital permission, while the user application 8 reads and uses this data. Furthermore, it is provided that the user 3 of the communication device 2 registers (logs in) to the training application by means of the user application 8, for example, by entering personal data, in particular a user name and password. Then, within the scope of method 1, the user 3 initiates a so-called key connection process, which they can achieve, for example, by activating an icon displayed by the user communication interface 14, which is displayed there specifically for carrying out the method 1.

It is essential that, during the key connection process, it is checked by means of the training application as to whether:
1) the user 3 is in the vehicle 4 or in the vehicle interior 4a of the vehicle 4, and a digital permission, which is stored in the database 16, to connect the new vehicle key 6 to the vehicle 4 has been provided for the user 3 in the backend application 9. Furthermore, it is checked as to whether the user is registered (logged in) to the training application, which, when the login was successful, enables a confirmation of the identity of the user.
2) the new vehicle key 6 is in the vehicle 4 or in the vehicle interior 4 a of the vehicle 4, and
3) the vehicle key 5 is in the vehicle 4, preferably in the vehicle interior 4a.

After successfully checking the criteria 1) to 3), it is provided that the new vehicle key 6 is communicatively connected to the vehicle 4 in a so-called coupling step.

When checking the criterion 1), an authentication request, together with a vehicle identification number of the vehicle 4, is first provided to the telematics application 15 provided in the vehicle backend 9 by means of the vehicle infotainment device 13, see point A in FIG. 1. Upon receipt of the authentication request, the telematics application 15 generates a random-based authentication code, e.g., a QR code, which has a unique authentication identifier, e.g., a UUID (Universally Unique Identifier). The generated authentication code and the vehicle identification number of the vehicle 4 are then allocated to each other by means of the telematics application 15 and stored as an authentication data packet in the telematics application 15. Moreover, the telematics application 15 provides the authentication code to the vehicle infotainment device 13 of the vehicle 4, see arrow B in FIG. 1, which displays the authentication code via the user communication interface 14 in the form of a QR code that can be read by the mobile communication device 2.

The displayed authentication code (QR code) is then provided to the mobile communication device 2 by a scanning process to be carried out by means of the mobile communication device 2. Thereupon, the communication device 2 provides the authentication code to the user application 8 such that it can provide the authentication code together with an identifier of a user session to the backend application 9, see arrow C in FIG. 1. Thereupon, the backend application 9 provides the authentication identifier of the authentication code to the telematics application 15, see arrow D in FIG. 1. The telematics application 15 then checks whether the provided authentication identifier of the authentication code is valid by searching for an authentication data packet in the telematics application 15 for the authentication identifier of the authentication code provided by the backend application 9, the authentication data packet having an authentication identifier that matches the authentication identifier provided by the backend application 9. The authentication identifier of the authentication code is valid if and only if an authentication data packet with a matching authentication identifier has been found. If authentication is successful, the telematics application 15 provides the vehicle identification number of the vehicle 4 to the backend application 9, see arrow E in FIG. 1. This confirms that the user 3 is in the vehicle 4 and that a digital permission to connect the new vehicle key 6 to the vehicle 4 is provided for the user 3 in the backend application 9.

When checking the criterion 2), a key identifier of the new vehicle key 6 is read from the new vehicle key 6 located in the vehicle 4 by means of the key communication interface 18 of the electronic ignition switch 17. Here it is provided that the key identifier of the new vehicle key 6 and the vehicle identification number of the vehicle 4 are provided to the telematics application 15, see arrow F in FIG. 1. Here, the telematics application 15 provides the key identifier of the new vehicle key 6 together with the vehicle identification number of the vehicle 4 to the backend application 9, see arrow G in FIG. 1. This ensures the presence of the new vehicle key 6 in the vehicle 4, which is essential for establishing a communication connection between the new vehicle key 6 and the vehicle 4.

When checking the criterion 3), a key presence query is transmitted to the telematics application 15 by means of the key data management application 19, see arrow H in FIG. 1. Here, the telematics application 15 sends the key presence query to the key communication interface 18 of the electronic ignition switch 17, see arrow I in FIG. 1. Thereupon, the ignition switch 17 locates the vehicle key 5, e.g., via radio, wherein the vehicle key 5 is identified and presence information is generated. Subsequently, the presence information is provided by the ignition switch 17, together with the vehicle identification number of the vehicle 4, to the telematics application 15, see arrow J in FIG. 1. The telematics application 15 provides the presence information along with the vehicle identification number of the vehicle 4 to the key data management application 19, see arrow K in FIG. 1, which in turn checks the presence information. This ensures the presence of the vehicle key 5 in the vehicle 4.

In the coupling step, in which the new vehicle key 6 is communicatively connected to the vehicle 4, it is provided that key programming data for connecting the new vehicle key 6 to the vehicle 4 is generated by the vehicle backend 10 and provides it to the vehicle 4. For this purpose, it is concretely provided that the backend application 9 generates a key programming request and sends it to the key data management application 19, see arrow L in FIG. 1. When, by means of checking the criterion 3), it is ensured that the vehicle key 5 is present in the vehicle 4, the key data management application 19 generates key programming data for the new vehicle key 6 and sends this to the telematics application 15, see arrow M in FIG. 1. The telematics application 15 in turn sends the key programming data via the telematics control device 22 to the key communication interface 18 of the ignition switch 17, see arrow N in FIG. 1. Thereupon, the ignition switch 17 sends the key programming data to the new vehicle key 6, where a communication connection can be established between the new vehicle key 6 and the vehicle 4 by means of the key programming data, such that the vehicle 4 can be used by the user 3 by means of the new vehicle key 6. Thus, the new vehicle key 6 can be easily and securely connected to the vehicle 4 in a communicative manner.

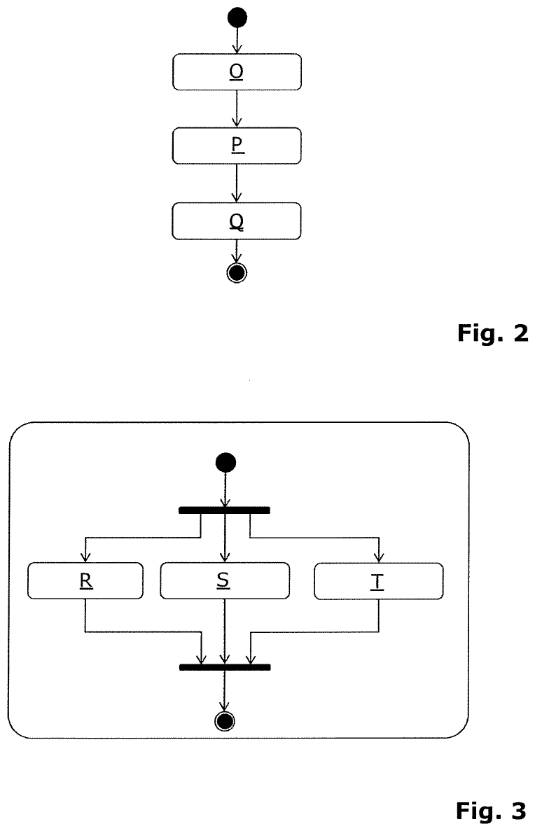

FIG. 2 shows a simplified schematic activity diagram of the proposed method 1, wherein only the essential method steps of the method 1, namely initiating the method 1 (box O), checking the criteria 1) to 3) (box P) and the coupling step (box Q) are depicted.

FIG. 3 shows a further simplified schematic activity diagram of the proposed method 1, in which checking the criteria 1) to 3) is depicted by boxes R to T.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-10. (canceled)

11. A method for establishing a communication connection between a new programmable vehicle key and a vehicle, the method comprising:
registering, by a user of a mobile communication device, with a training application;
initiating, by the user of the mobile communication device a key connection process, which comprises
checking, by a training application, as to whether
1) a user is in the vehicle, a backend application has provided a digital permission to connect the new programmable vehicle key to the vehicle for the user, and the user is registered to the training application;
2) the new programmable vehicle key is in the vehicle; and
3) a programmable vehicle key is in the vehicle; and
communicatively connecting, following a successful checking of 1) to 3), the new programmable vehicle key to the vehicle in a coupling step,
wherein the programmable vehicle key is communicatively connected to the vehicle,
wherein a mobile communication device comprises a storage medium storing the training application, which is an executable user application, and
wherein the backend application is in a vehicle backend and is wirelessly communicatively connected to the mobile communication device.

12. The method of claim 11, wherein
the coupling step comprises the vehicle backend generating and providing, to the vehicle, key programming data for connecting the new programmable vehicle key to the vehicle,
the vehicle provides the key programming data to the new programmable vehicle key, and
a communication connection is established between the new programmable vehicle key and the vehicle by the key programming data, such that the vehicle is usable by the user by the programmable new vehicle key.

13. The method of claim 11, wherein the key connection process is initialized by the user using a user communication interface of a vehicle infotainment device of the vehicle.

14. The method of claim 11, wherein
when checking 1), an authentication request is provided with a vehicle identification number of the vehicle to a telematics application provided in the vehicle backend by a vehicle infotainment device of the vehicle,
the telematics application generates a random-based authentication code having a unique authentication identifier upon receipt of the authentication request,
the generated random-based authentication code and the vehicle identification number of the vehicle are allocated to each other by the telematics application and stored as an authentication data packet in the telematics application,
the telematics application provides the random-based authentication code to the vehicle infotainment device of the vehicle,
the vehicle infotainment device of the vehicle has a user communication interface for the user, wherein the random-based authentication code is provided and displayed at the user communication interface,
the displayed random-based authentication code is provided to the mobile communication device, which provides the random-based authentication code to the executable user application,
the executable user application provides the random-based authentication code together with an authentication identifier of a user session to the backend application,
the backend application performs a request in which the authentication identifier of the random-based authentication code is provided to the telematics application,
the telematics application checks whether the provided authentication identifier of the random-based authentication code is valid by searching for an authentication data packet in a database of the vehicle backend for the authentication identifier of the random-based authentication code provided by the backend application, the authentication data packet having an authentication identifier matching the authentication identifier provided by the backend application,
the authentication identifier of the random-based authentication code is valid when an authentication data packet with a matching authentication identifier is found, and
the telematics application, upon successful authentication, provides the vehicle identification number of the vehicle to the backend application to confirm that the user is in the vehicle and that a digital permission to connect the new programmable vehicle key to the vehicle has been provided for the user in the backend application.

15. The method of claim 11, wherein
when checking 2), a key identifier of the new programmable vehicle key located in the vehicle is read from the new programmable vehicle key by a key communication interface of an electronic ignition switch of the vehicle,
the key identifier of the new programmable vehicle key and a vehicle identification number of the vehicle are provided to a telematics application provided in the vehicle backend, and
the telematics application provides the key identifier of the new programmable vehicle key together with the vehicle identification number of the vehicle to the backend application.

16. The method of claim 11, wherein
when checking 3), a key presence query is transmitted to a telematics application provided in the vehicle backend by a key data management application provided in the vehicle backend,
the telematics application sends a key presence query to a key communication interface of an electronic ignition switch of the vehicle,
the electronic ignition switch identifies the programmable vehicle key and generates presence information,
the electronic ignition switch provides the presence information with a vehicle identification number of the vehicle to the telematics application, and
the telematics application provides the presence information with the vehicle identification number of the vehicle to the key data management application, and the key data management application checks the presence information.

17. The method of claim 11, wherein the key connection process, the mobile communication device communicates wirelessly with the vehicle via a user communication interface of a vehicle infotainment device of the vehicle.

18. The method of claim 11, wherein the new programmable vehicle key or the programmable vehicle key communicates wirelessly with the vehicle via a key communication interface of an electronic ignition start switch of the vehicle as part of the key connection process.

19. The method of claim 11, wherein the mobile communication device or a vehicle infotainment device of the vehicle communicates wirelessly with the vehicle backend via a mobile radio network.

20. A system comprising:
a vehicle;
a vehicle backend allocated to the vehicle;
a mobile communication device with a storage medium, a programmable vehicle key communicatively connected to the vehicle;
a programmable new vehicle key that can be communicatively connected to the vehicle;
a training application having an executable user application stored in the storage medium of the mobile communication device;
an executable backend application provided in the vehicle backend and wirelessly communicatively connected to the mobile communication device,
wherein the vehicle has an electronic ignition switch with a key communication interface configured to communicate with the programmable vehicle key and the new programmable vehicle key, and a vehicle infotainment device with a user communication interface configured to communicate with a user,
wherein the vehicle backend further comprises a telematics application, a database allocated to the executable backend application, and a key data management application,
wherein the training application is configured as part of a key connection process to
1) check whether a user is in the vehicle, a backend application has provided a digital permission to connect the new programmable vehicle key to the vehicle for the user, and the user is registered to the training application;
2) check whether the new programmable vehicle key is in the vehicle; and
3) check whether the programmable vehicle key is in the vehicle,
wherein the vehicle is configured, following a successful checking of 1) to 3), communicatively couple the new programmable vehicle key to the vehicle in a coupling step.
